(19) United States
(12) Patent Application Publication
(10) Pub. No.: US 2025/0372822 A1
(43) Pub. Date: Dec. 4, 2025

(54) CONFIGURATIONS FOR OPTIMIZING BATTERY CELL-TO-BUSBAR ELECTRICAL CONNECTIONS

(71) Applicant: FORD GLOBAL TECHNOLOGIES, LLC, Dearborn, MI (US)

(72) Inventor: Brian UTLEY, Canton, MI (US)

(21) Appl. No.: 18/676,912

(22) Filed: May 29, 2024

(51) Int. Cl. H01M 50/503; B60L 50/64; H01M 50/211; H01M 50/505; H01M 50/516; H01M 50/557

(52) U.S. Cl. CPC H01M 50/503; B60L 50/64; H01M 50/211; H01M 50/505; H01M 50/516; H01M 50/557; H01M 2220/20

(57) ABSTRACT

Battery cell tab terminal-to-busbar configurations are provided for electrically connecting battery cells within a traction battery pack. The tab terminals may be secured to the busbar within a space that extends between the battery cells and the busbar in order to reduce the amount of packaging space required for electrically connecting the battery cells and thus reduce the overall tab terminal-to-busbar footprint. In one implementation, the tab terminals are secured to a flat surface of the busbar and are forced into contact with the flat surface by a backing plate. In other implementations, the tab terminals are secured to angled portions of the busbar.

### TECHNICAL FIELD

This disclosure relates generally to electrified vehicle traction battery packs, and more particularly to techniques for electrically connecting battery cells of traction battery packs.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

A traction battery pack according to an exemplary aspect of the present disclosure includes, among other things, a battery cell including a housing and a tab terminal extending from the housing. The tab terminal includes a bent tab end section, a busbar arranged adjacent to the bent tab end section of the tab terminal, a backing plate that receives the bent tab end section, and a weld that secures the bent tab end section to the busbar.

In a further non-limiting embodiment of the foregoing traction battery pack, the weld is a laser weld.

In a further non-limiting embodiment of either of the foregoing traction battery packs, the weld is formed at a flat surface of the busbar to join with the bent tab end section of the battery cell.

In a further non-limiting embodiment of any of the foregoing traction battery packs, the backing plate is configured to provide a force for urging the bent tab end section into a suitable welding position relative to the first flat surface of the busbar.

In a further non-limiting embodiment of any of the foregoing traction battery packs, the bent tab end section is urged against an angled surface of the backing plate by a comb-like structure.

In a further non-limiting embodiment of any of the foregoing traction battery packs, the comb-like structure includes a slot that receives the tab terminal. The slot is circumscribed by a gentle surface.

In a further non-limiting embodiment of any of the foregoing traction battery packs, the backing plate is part of a busbar frame that is secured to the busbar. The busbar frame and the busbar together establish a bus bar module of the traction battery pack.

In a further non-limiting embodiment of any of the foregoing traction battery packs, the bent tab end section includes a proximal tip portion and a distal tip portion that is folded toward the proximal tip portion about a bend.

In a further non-limiting embodiment of any of the foregoing traction battery packs, the proximal tip portion extends in a first plane, and the housing of the battery cell extends in a second plane that is about perpendicular to the first plane.

In a further non-limiting embodiment of any of the foregoing traction battery packs, the bend is received against an angled surface of the backing plate.

In a further non-limiting embodiment of any of the foregoing traction battery packs, the weld is flanked by a pair of viewing windows that extend through a body of the busbar.

A traction battery pack according to another exemplary aspect of the present disclosure includes, among other things, a battery cell including a housing and a tab terminal extending from the housing, a busbar including a flared portion that extends in a direction toward the housing of the battery cell to a position adjacent to the tab terminal, and a weld that secures the tab terminal to the flared portion.

In a further non-limiting embodiment of the foregoing traction battery pack, the flared portion is provided at an opening of the busbar.

In a further non-limiting embodiment of either of the foregoing traction battery packs, the flared portion extends in a direction toward the battery cell.

In a further non-limiting embodiment of any of the foregoing traction battery packs, a tab end section of the tab terminal is received against an angled surface of the flared portion.

In a further non-limiting embodiment of any of the foregoing traction battery packs, the weld joins the tab end section to the angled surface.

In a further non-limiting embodiment of any of the foregoing traction battery packs, the tab end section is located in a space between the busbar and the housing of the battery cell when secured by the weld.

In a further non-limiting embodiment of any of the foregoing traction battery packs, the angled surface provides a flat welding surface for joining the tab end section to the flared portion.

In a further non-limiting embodiment of any of the foregoing traction battery packs, a proximal tip portion of the tab end section extends in a first plane, and the housing of the battery cell extends in a second plane that is greater than perpendicular relative to the first plane.

In a further non-limiting embodiment of any of the foregoing traction battery packs, the busbar is comprised of a first metallic material, and the tab terminal is comprised of a second metallic material that is different from the first metallic material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack of an electrified vehicle.

FIG. 3 is a highly schematic cross-sectional view of the traction battery pack of FIG. 2.

FIG. 4 illustrates a battery cell for use within a traction battery pack.

FIG. 5 illustrates a busbar module configured for joining tab terminals of a grouping of battery cells.

FIG. 6 is a cross-sectional view through section 6-6 of FIG. 5.

FIG. 7 illustrates an exemplary shape of an end section of a battery cell tab terminal.

FIG. 8 is a cross-sectional view of an exemplary busbar for joining tab terminals of a grouping of battery cells.

FIG. 9 is a perspective view of the busbar of FIG. 8.

### DETAILED DESCRIPTION

This disclosure details exemplary battery cell tab terminal-to-busbar configurations for electrically connecting battery cells within a traction battery pack. The tab terminals may be secured to the busbar within a space that extends between the battery cells and the busbar in order to reduce the amount of packaging space required for electrically connecting the battery cells and thus reduce the overall tab terminal-to-busbar footprint. In one implementation, the tab terminals are secured to a flat surface of the busbar and are forced into contact with the flat surface by a backing plate. In other implementations, the tab terminals are secured to angled portions of the busbar. These and other features are discussed in greater detail in the following paragraphs of this detailed description.

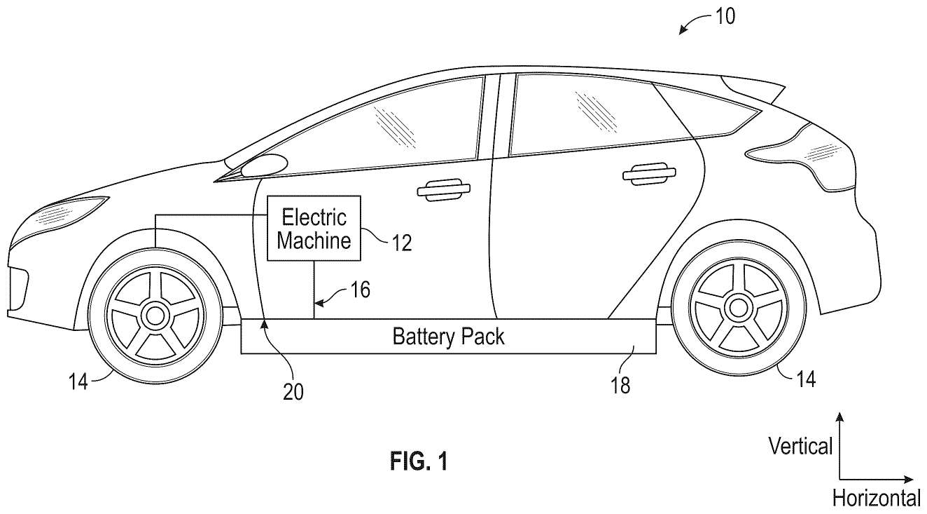

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

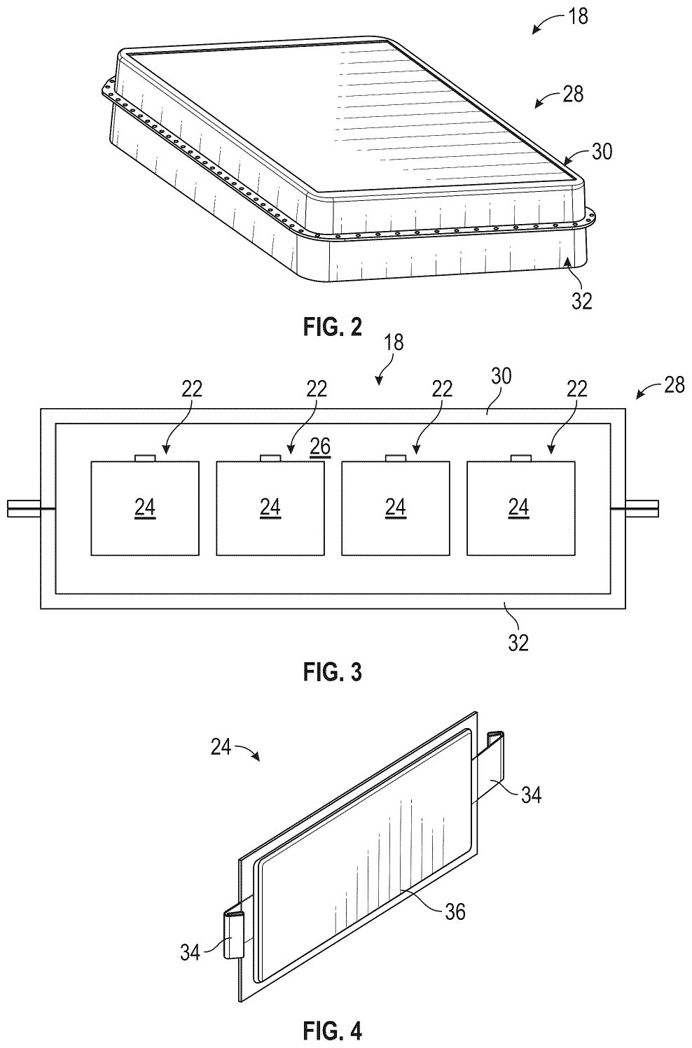

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total numbers of battery arrays 22 and battery cells 24 provided within the traction battery pack 18 are not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 (see FIG. 3) of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

FIG. 4 illustrates one of the battery cells 24 that can be provided within the traction battery pack 18. Each battery cell 24 may include a housing 36 and a pair of tab terminals 34 that project outwardly from the housing 36. In an embodiment, each battery cell 24 includes two tab terminals 34, with one tab terminal 34 protruding outwardly at each opposing side of the housing 36. One of the tab terminals 34 may be provide the positive terminal of the battery cell 24, and the other tab terminal 34 may provide the negative terminal of the battery cell 24. However, other configurations are further contemplated within the scope of this disclosure.

The tab terminals 34 of the battery cells 24 of each battery array 22 must be reliably connected to one another in order to provide the voltage and power levels necessary for achieving vehicle propulsion. Busbars are sometimes used for making these connections, however, it can be difficult to properly position and align the tab terminals 34 relative to the busbar during assembly and welding processes. Moreover, the busbars are typically thicker than the tab terminals 34, thereby introducing welding complexities that can result in weld-through and/or weld spatter. Additionally, some weld joint designs for electrically coupling the busbars may be oriented to occupy excessive volume, or package space, inside the battery array 22 or the traction battery pack 18. This disclosure is therefore specifically directed to tab terminal and busbar shape variations that can be used for optimizing battery cell-to-busbar electrical connections and thus reducing the required packaging space of each battery array 22.

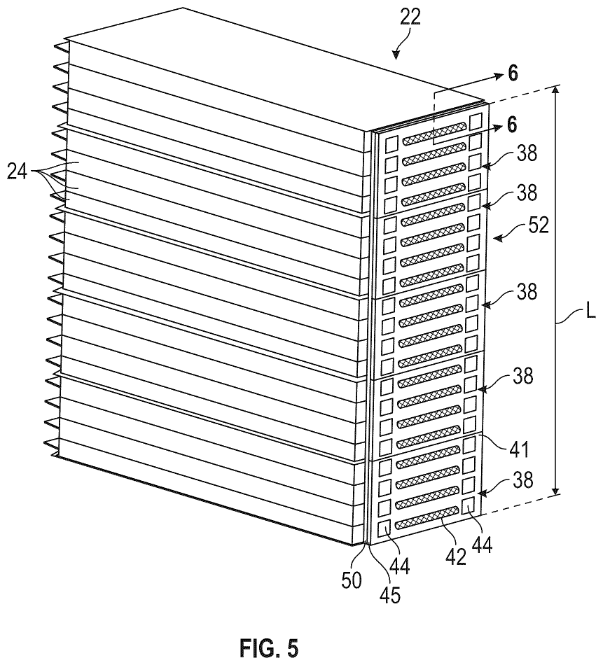

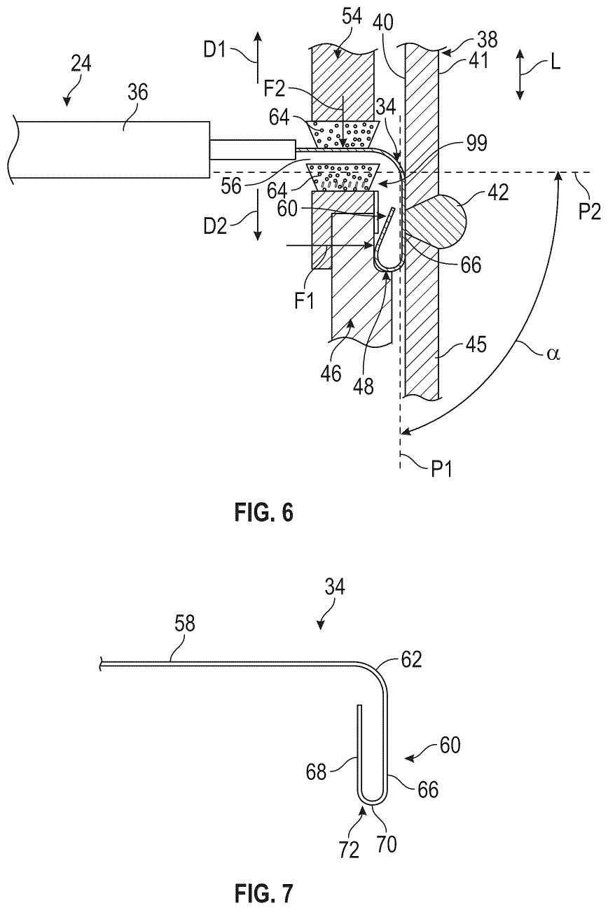

FIGS. 5 and 6 illustrate busbars 38 that can be joined to the tab terminals 34 of a grouping of battery cells 24 for electrically connecting the battery cells 24. The grouping of battery cells 24 may be part of one of the battery arrays 22 of the traction battery pack 18, for example. Once electrically coupled, the battery cells 24 may supply electrical power for powering various components of the electrified vehicle 10.

The tab terminals 34 and the busbars 38 may be metallic components. In an embodiment, the busbars 38 are made of copper or aluminum, and the tab terminals are made of aluminum. However, other materials or combinations of materials are contemplated within the scope of this disclosure.

The tab terminals 34 may be joined to a first flat surface 40 of the busbar 38 by one or more welds 42 (e.g., laser welds). The first flat surface 40 may face in a direction toward the housings 36 of the battery cells 24, and a second flat surface 41 of the busbar 38 may face in a direction away from the housings 36. The welds 42 may be linear welds, non-linear welds, or any other weld patterns. A laser beam (e.g., from a welding tool) may pass through an opening of the busbar 38 to form the weld 42, thereby joining the busbar 38 to the tab terminal 34 of the battery cell 24.

The busbar 38 may include a plurality of viewing windows 44. Each viewing window 44 may be formed through a body 45 of the busbar 38 and is configured to visualizing one or more of the tab terminals 34 from an opposite side of the busbar 38 from the battery cells 24 (i.e., from outside the second flat surface 41). In an embodiment, each weld 42 is flanked by a pair of the viewing windows 44.

The shape of each tab terminal 34 may be specifically designed to optimize the battery cell-to-busbar electrical connection. For example, as shown in FIG. 7, the tab terminals 34 may each include a tab proximal section 58 that extends from cell internal electrodes to a position outside of the housing 36 of the battery cell 24. The tab proximal section 58 may be substantially straight along its length. The tab terminal 34 may additionally include a first bend 62 that positions a tab end section 60 at an angle relative to the tab proximal section 58. The tab end section 60 may include a proximal tip portion 66 and a distal tip portion 68. The distal tip portion 68 may be folded toward the proximal tip portion 66 about a second bend 70. Once folded, the distal tip portion 68 may contact the proximal tip portion 66 or could be slightly spaced therefrom.

Together, the proximal tip portion 66, the distal tip portion 68, and the second bend 70 may establish a crimped portion 72 of the tab end section 60. The crimped portion 72 provides a local thickness increase at the tab end section 60 of the tab terminal 34. The tab terminal 34 is thus less prone to weld-through and effectively limits weld spatter in a direction toward the battery cell 24 during the process of welding the tab end section 60 of the tab terminal 34 to the busbar 38.

Referring now primarily to FIG. 6, a backing plate 46 may help locate and position the tab terminals 34 relative to the first flat surface 40 of the busbar 38 during assembly and welding operations. The backing plate 46 may include an angled surface 48 that is sized to receive the tab end section 60 of the tab terminal 34 and to urge, via a reactionary force F1, the tab end section 60 into a suitable welding position relative to the first flat surface 40 of the busbar 38. The second bend 70 of the tab end section 60 may be received directly against the angled surface 48.

The backing plate 46 may be part of a busbar frame 50 (see FIG. 5) that can be attached to the busbars 38. Together, the busbars 38 and the busbar frame 50 establish a bus bar module 52.

A comb-like structure 54 may be utilized to adjust a position of the tab terminal 34 along a length L of the busbar 38. The comb-like structure 54 may include a slot 56 sized to receive the tab terminal 34. The comb-like structure 54 may be moved in either a first direction D1 or a second direction D2 to alter a position of the tab terminal 34 relative to the busbar 38. The first direction D1 and the second direction D2 extend in parallel with the length L of the busbar 38.

The slot 56 may be circumscribed by a gentle surface 64 of the comb-like structure 54. The gentle surface 64 may be made of foam or some other gentle material that prevents damaging the tab terminal 34 as the comb-like structure 54 is moved in either the first direction D1 or the second direction D2 during assembly.

When the comb-like structure 54 is moved in the second direction D2, the gentle surface 64 may apply a force F2 to tab terminal 34 for urging the tab end section 60 into engagement against the angled surface 48 of the backing plate 46. The force F2, combined with the reactionary force F1, may thus act as a clamping force for clamping the terminal 34 between the busbar 38 and the backing plate 46.

In an embodiment, the comb-like structure 54 is a temporary build fixture that can be removed after completing the welding process. In another embodiment, the comb-like structure 54 is incorporated as part of the busbar frame 50.

When the tab end section 60 has been moved into proper welding position relative to the busbar 38 by the comb-like structure 54 and the backing plate 46, the proximal tip portion 66 of the tab terminal 34 may extend in a first plane P1 that is angled at an angle α relative to a second plane P2 that extends through the housing 36 of the battery cell 24. In an embodiment, the angle α is about 90 degrees. In this disclosure, the term “about” means that the expressed quantities or ranges need not be exact but may be approximated and/or larger or smaller, reflecting acceptable tolerances, conversion factors, measurement error, etc. However, other angles are contemplated within the scope of this disclosure. By locating the weld surface of the tab terminal 34 in a space 99 that extends between the busbar 38 and the battery cell 24, the busbar 38 can be positioned closer to the housing 36 of the battery cell 24, thereby reducing the overall packaging space necessary for the battery array 22.

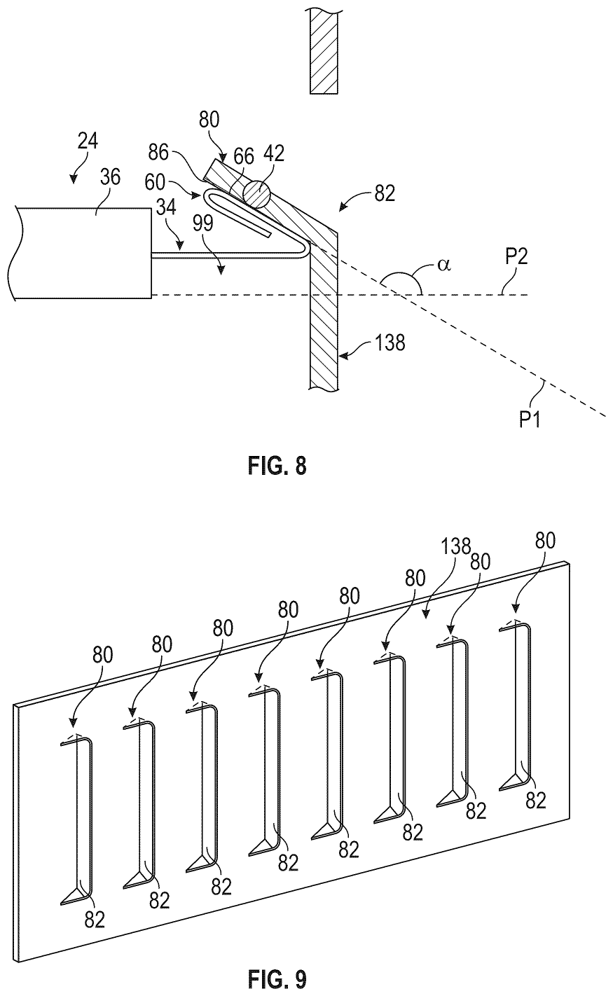

FIGS. 8 and 9 illustrate another exemplary busbar 138 that can be joined to the tab terminals 34 of a grouping of battery cells 24 for electrically connecting the battery cells 24. The busbar 138 may include a plurality of flared portions 80 at which the tab terminals 34 may interface with the busbar 138. One flared portion 80 may be provided at each opening 82 that is formed through the busbar 138. In another embodiment, the openings 82 could be formed when stamping/forming the flared portions 80.

Each flared portion 80 may extend in a direction toward the battery cells 24 of the battery cell grouping. The tab end section 60 of the tab terminals 34 may be received against an angled surface 86 of the flared portion 80. Each angled surface 86 may provide a relatively flat surface for creating one or more welds 42 for joining the tab end section 60 of the tab terminal 34 with the angled surface 86 of the flared portion 80.

When the tab end section 60 has been moved into proper welding position relative to the flared portion 80 of the busbar 138, the proximal tip portion 66 of the tab terminal 34 may extend in a first plane P1 that is angled at an angle α relative to a second plane P2 that extends through the housing 36 of the battery cell 24. In an embodiment, the angle α is greater than 90 degrees. In another embodiment, the angle α is about 120 degrees. However, other angles are contemplated within the scope of this disclosure.

By locating the weld surface of the tab terminal 34 in the space 99 that extends between the busbar 138 and the battery cell 24, the busbar 138 can be placed closer to the housing 36 of the battery cell 24, thereby reducing the overall packaging space necessary for the battery array 22.

The exemplary tab terminal and busbar shape variations described above are designed to reduce the amount of packaging space required for electrically connecting battery cells. The proposed designs facilitate tab terminal-to-busbar connections that can be achieved by providing weld surfaces that are located in the space between battery cell housings and the busbar, thereby significantly reducing the overall footprint of the array.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell including a housing and a tab terminal extending from the housing, wherein the tab terminal includes a bent tab end section;
a busbar arranged adjacent to the bent tab end section of the tab terminal;
a backing plate that receives the bent tab end section; and
a weld that secures the bent tab end section to the busbar.

2. The traction battery pack as recited in claim 1, wherein the weld is a laser weld.

3. The traction battery pack as recited in claim 2, wherein the weld is formed at a flat surface of the busbar to join with the bent tab end section of the battery cell.

4. The traction battery pack as recited in claim 2, wherein the backing plate is configured to provide a force for urging the bent tab end section into a suitable welding position relative to the first flat surface of the busbar.

5. The traction battery pack as recited in claim 1, wherein the bent tab end section is urged against an angled surface of the backing plate by a comb-like structure.

6. The traction battery pack as recited in claim 5, wherein the comb-like structure includes a slot that receives the tab terminal, and further wherein the slot is circumscribed by a gentle surface.

7. The traction battery pack as recited in claim 1, wherein the backing plate is part of a busbar frame that is secured to the busbar, and further wherein the busbar frame and the busbar together establish a bus bar module of the traction battery pack.

8. The traction battery pack as recited in claim 1, wherein the bent tab end section includes a proximal tip portion and a distal tip portion that is folded toward the proximal tip portion about a bend.

9. The traction battery pack as recited in claim 8, wherein the proximal tip portion extends in a first plane, and the housing of the battery cell extends in a second plane that is about perpendicular to the first plane.

10. The traction battery pack as recited in claim 8, wherein the bend is received against an angled surface of the backing plate.

11. The traction battery pack as recited in claim 1, wherein the weld is flanked by a pair of viewing windows that extend through a body of the busbar.

12. A traction battery pack, comprising:
a battery cell including a housing and a tab terminal extending from the housing;
a busbar including a flared portion that extends in a direction toward the housing of the battery cell to a position adjacent to the tab terminal; and
a weld that secures the tab terminal to the flared portion.

13. The traction battery pack as recited in claim 12, wherein the flared portion is provided at an opening of the busbar.

14. The traction battery pack as recited in claim 12, wherein the flared portion extends in a direction toward the battery cell.

15. The traction battery pack as recited in claim 14, wherein a tab end section of the tab terminal is received against an angled surface of the flared portion.

16. The traction battery pack as recited in claim 15, wherein the weld joins the tab end section to the flared portion.

17. The traction battery pack as recited in claim 16, wherein the tab end section is located in a space between the busbar and the housing of the battery cell when secured by the weld.

18. The traction battery pack as recited in claim 16, wherein the angled surface provides a flat welding surface for joining the tab end section to the flared portion.

19. The traction battery pack as recited in claim 16, wherein a proximal tip portion of the tab end section extends in a first plane, and the housing of the battery cell extends in a second plane that is greater than perpendicular relative to the first plane.

20. The traction battery pack as recited in claim 12, wherein the busbar is comprised of a first metallic material, and the tab terminal is comprised of a second metallic material that is different from the first metallic material.
